(19) United States
(12) Patent Application Publication
(10) Pub. No.: US 2026/0330258 A1
(43) Pub. Date: Oct. 22, 2026

(54) GENERATIVE QUERY-BASED SYSTEMS AND METHODS FOR OPERATING THE SAME

(71) Applicant: T-Mobile USA, Inc., Bellevue, WA (US)

(72) Inventors: Akbar Ali Chabuk Savar, Lynnwood, WA (US); Jorgen August Skriver Rasmussen, Sammamish, WA (US)

(21) Appl. No.: 19/183,540

(22) Filed: Apr. 18, 2025

(51) Int. Cl. G06N 5/04; G06F 40/226

(52) U.S. Cl. CPC G06N 5/04; G06F 40/226

(57) ABSTRACT

Systems and methods are disclosed comprising instructions to receive a user query for information associated with a telecommunications network, retrieve a recorded context dialogue of previously generated responses to prior user queries associated with the received user query, determine a sequential model set of generative models configured to generate natural language responses to input user queries using network data of the telecommunications network, cause the generative models to generate candidate responses to the received user query using the recorded context dialogue and network data corresponding to the accessible network data type of the generative model, access a validation schema that defines a natural language feature set for identifying invalid candidate responses generated via the generative model, and display the candidate response at the user interface in response to the generated candidate response satisfying the natural language feature set of the validation schema.

### BACKGROUND

A large language model (LLM) represents an advanced category of machine learning models specifically designed for natural language processing tasks, including language generation. These models are characterized by a substantial number of parameters and are trained using self-supervised learning techniques on extensive text corpora. Among the most sophisticated and capable LLMs are the generative pretrained transformers (GPTs). Contemporary models can be fine-tuned for particular tasks or directed through prompt engineering. These models develop predictive capabilities concerning the syntax, semantics, and ontologies inherent in human language corpora. However, they also inherit the inaccuracies and biases present in the training data.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2A is a block diagram that illustrates a generative query system that can implement aspects of the present technology.

FIG. 2B is a block diagram that illustrates example processes of the generative query system in accordance with one or more implementations of the disclosed technology.

FIG. 3 is a flow diagram that illustrates an example process for generating query responses in accordance with some implementations of the disclosed technology.

FIG. 4 is a system diagram illustrating an example of a computing environment that can implement aspects of the present technology.

FIG. 5 illustrates a layered architecture of an artificial intelligence (AI) system that can implement the ML models of the generative query system in accordance with some implementations of the present technology.

FIG. 6 is a block diagram of an example transformer that can implement aspects of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Generation of substantive and practical natural language responses (e.g., context-aware recommendations) via generative models (e.g., large language models, natural language processing algorithms, and/or the like) often requires extensive training and contextual prompt engineering using significant quantities of disparate knowledge domains and/or data sources (e.g., structured and unstructured network data for a telecommunications network). However, enterprise applications (e.g., a generative database query system) using internal data sources are often restricted by stringent data access policies and/or protections. For example, access to sensitive internal data, such as functional intellectual property (e.g., code repositories, operational network information, and/or the like), customer identifiable information (e.g., legal names, resident addresses, government issued identities, and/or the like) and/or financial records (e.g., bank account details, transaction histories, and/or the like), is typically reserved to a select group of authorized users and/or identities.

These layers of separation often limit conventional systems to using generative language models of smaller and/or specialized knowledge bases when addressing user queries (e.g., a question and/or request associated with system data). As a result, these individual language models are often unable to provide comprehensive responses to complex user queries that involve holistic evaluations of disparate data sources. For example, a generative model that specializes in answering user queries directed towards real-time hardware information (e.g., base station network coverage for specified geographic locations) is ill equipped to fully answer a user query partially involving internal firmware data (e.g., functional code information). To generate complete and/or satisfactory responses to user queries, conventional systems typically rely on manual vetting of multiple specialized or small-scale language models. For example, conventional systems rely on the end user (e.g., a human analyst) to manually query a plurality of generative models and validate each natural language response to identify the most suitable response to the initial user query. Such manual validation can be an expensive process that often requires considerable time and resources while delaying provision of accurate and relevant information to the user. As a result, these and other problems can significantly diminish the overall end user experience and place additional undue burden on enterprise developers (e.g., maintenance staff for telecommunications service providers), third parties, and so forth.

Disclosed herein are systems and related methods for iteratively generating valid natural language responses to user queries for information associated with a telecommunications network. The disclosed system can be configured to generate a sequence of generative models (e.g., natural language processing algorithms, large language models, and/or the like) for evaluating a plurality of candidate natural language responses to a received user query (e.g., a text-based request). The disclosed system can identify and order the generative models based on network data types (e.g., structured/unstructured data structures, privileged information, and/or the like) that are accessible to each generative model and relevant to the received user query. Accordingly, the disclosed system can automatically generate iterative natural language responses to the initial user query until a candidate response (e.g., current iteration response) satisfies a validation criteria (e.g., excludes invalid response features).

For illustrative purposes, examples are described herein in the context of computer systems for generating comprehensive natural language responses to user queries for information associated with telecommunications networks and/or service providers. However, a person skilled in the art will appreciate that the disclosed system can be applied in other contexts. For example, the disclosed system can be used within cybersecurity systems to iteratively output an optimal user query response from a plurality of separate data management systems that are each limited to a particular data type (e.g., different data accessibility and/or visibility).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Wireless Communications System

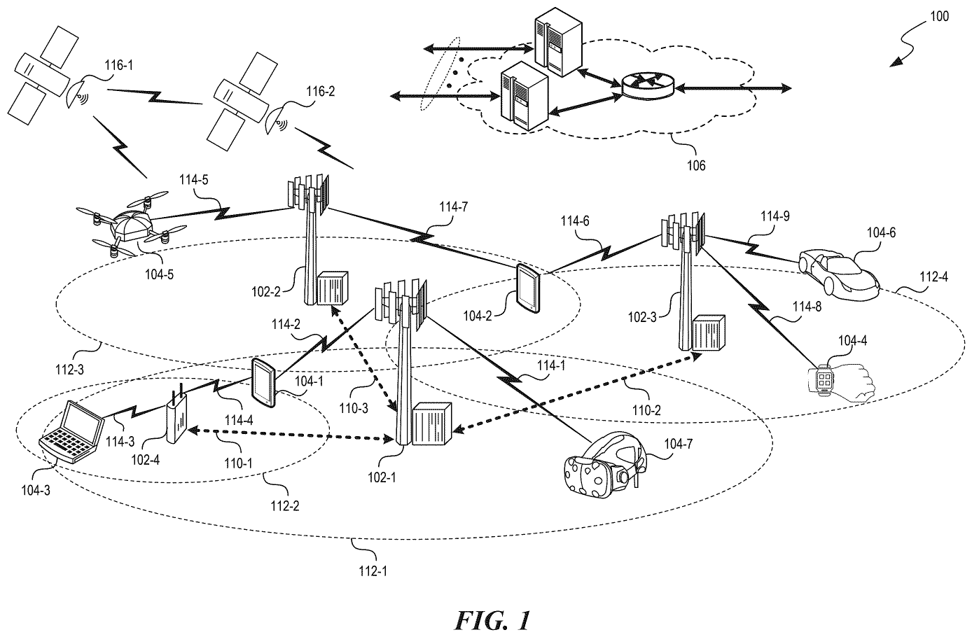

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Generative Query System

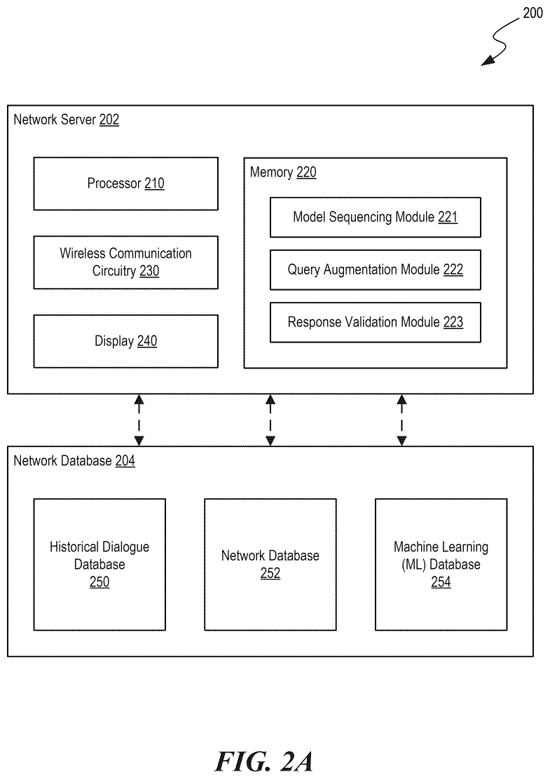

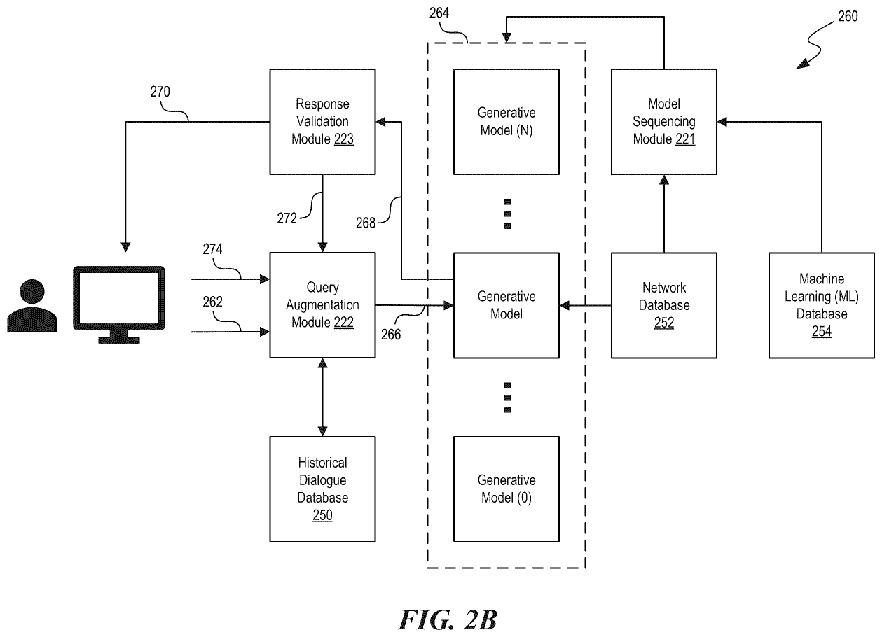

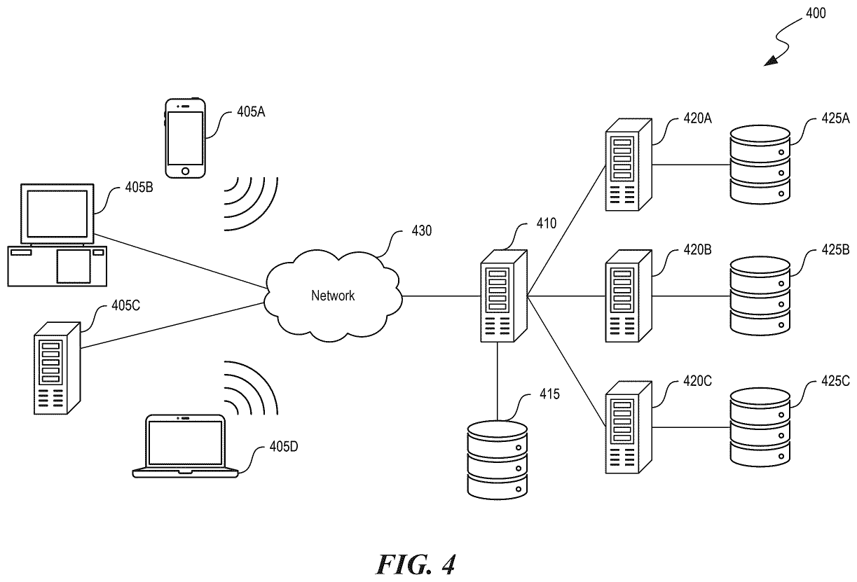

FIG. 2A is a block diagram that illustrates a generative query system 200 (“system 200”) that can implement aspects of the present technology. The components shown in FIG. 2A are merely illustrative, and well-known components are omitted for brevity. As shown, the network server 202 includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). The processor 210 can have generic characteristics similar to general-purpose processors, or the processor 210 can be an application-specific integrated circuit (ASIC) that provides arithmetic and control functions to the network server 202. While not shown, the processor 210 can include a dedicated cache memory. The processor 210 can be coupled to all components of the network server 202, either directly or indirectly, for data communication. Further, the processor 210 of the network server 202 can be communicatively coupled to a network database 204 that is hosted alongside the network server 202 on the core network 406 described in reference to FIG. 4. As shown, the network database 204 can include a historical dialogue database 250, a network database 254, and a machine learning (ML) database 254.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional, or alternative, embodiments, the processor 210 can store temporary information onto the memory 220 and store long-term data onto the network database 204. The memory 220 is merely an abstract representation of a storage environment. Hence, in some embodiments, the memory 220 comprises one or more actual memory chips or modules.

As shown in FIG. 2A, modules of the memory 220 can include a model sequencing module 221, a query augmentation module 222, and a response validation module 223. Other implementations of the network server 202 include additional, fewer, or different modules, or distribute functionality differently between the modules. As used herein, the term “module” and/or “engine” refers broadly to software components, firmware components, and/or hardware components. Accordingly, the modules 221, 222, and 223 could each comprise software, firmware, and/or hardware components implemented in, or accessible to, the network server 202.

FIG. 2B is a block diagram that illustrates example processes 260 of the generative query system in accordance with one or more implementations of the disclosed technology. As shown in FIG. 2B, the query augmentation module 222 can be configured to receive (e.g., via a text box and/or chat box interface) an input user query 262 (e.g., an alphanumeric text) requesting information associated with a telecommunications network. In some implementations, the query augmentation module 222 can be configured to modify the initial user query 262 using additional context information retrieved from the historical dialogue database 250. For example, the query augmentation module 222 can generate a supplementary query (e.g., a preliminary input query for generative models) and/or a contextual overhead (e.g., a preamble text to initial user query) that includes prior user queries and corresponding responses generated via generative machine learning models (e.g., natural language processing algorithms, large language models, and/or the like).

In some implementations, the model sequencing module 221 can be configured to generate an ordered sequence 264 of generative models based on network information stored in the network database 252 and machine learning models stored in the machine learning database 254. For example, the model sequencing module 221 can identify a relational mapping between each available generative model stored in database 254 to network data types (e.g., structured/unstructured data, privileged/unprivileged data, and/or the like) accessible to the generative model. Accordingly, the model sequencing module 221 can order the sequence 264 of generative models according to a ranking pattern based on the accessible data types mapped to each generative model (e.g., decreasing data authorization/privilege level, increasing denormalization of data structure, and/or the like). In some implementations, the model sequencing module 221 can order the sequence 264 based on a comparison of the input user query 262 to the data types accessible to each generative model. For example, the model sequencing module 221 can generate (e.g., via a machine learning model) a ranked order of available data types (e.g., of the network database 252) based on strength of content similarities for each available data type to the user query 262. Using the ranked order of available data types, the model sequencing module 221 can generate a ranked order of generative models that prioritizes generative models with access to network data types with higher content similarity strength to the user query 262.

In some implementations, the system 200 can iteratively generate candidate natural language responses to the user query 262 using a modified query 266 generated via the query augmentation module 222. For example, the system 200 can cause a select generative model (e.g., current model in sequence) to generate a candidate response 268 to the modified query 266 using network data from the network database 252 that is accessible to the select generative model. In some implementations, the response validation module 223 can evaluate whether the candidate response 268 generated by the select generative model satisfies minimum criteria for responding to a user query 262. For example, the response validation module 223 can access a validation schema that comprises a set of natural language features (e.g., alphanumeric keywords, predefined output data structure, and/or the like) that represent invalid natural language responses to the user query 262. As a non-limiting example, invalid natural language responses can include a default messaging pattern of a generative model in response to failure of generating a satisfactory response to the user query 262. In response to validating that the candidate response 268 satisfies the validation schema for the user query 262, the response validation module 223 can automatically transmit the validated response 270 for display at the user interface (e.g., a chat box response to user query 262). In response to invalidating the candidate response 268 as not satisfying the validation schema, the response validation module 223 can automatically transmit a trigger 272 to the query augmentation module 222 for causing the next generative model in the sequence 264 to generate a new candidate response 268 for the modified query 266.

In some implementations, the system 200 can be configured to generate a new candidate response 268 in response to user evaluation of the validated response 270. For example, the system can be configured to receive a negative user response 274 indicating rejection of the displayed response 270 to the initial user query 262. Accordingly, the query augmentation module 222 can cause the next generative model in the sequence 264 to generate a new candidate response 268 for the modified query 266. In some implementations, the query augmentation module 222 can be configured to dynamically generate new context information for the modified query 266 in response to receiving a negative user response 274. For example, the query augmentation module 222 can input the original modified query 266 and the rejected validated response 270 as an additional historical dialogue sample for the user query 262 when generating an updated modified query 266.

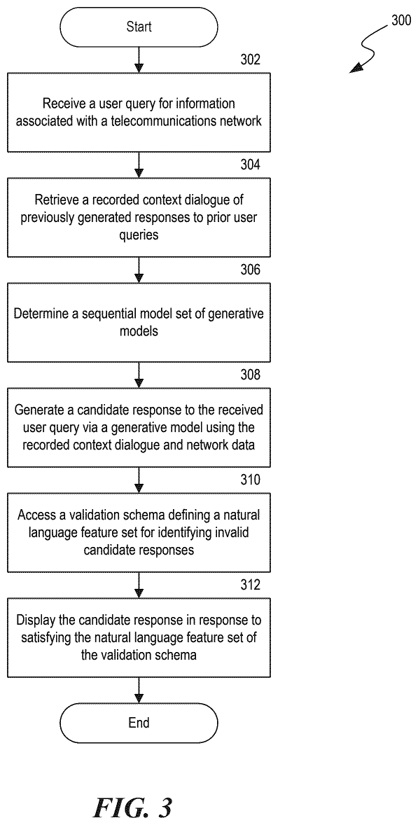

FIG. 3 is a flow diagram that illustrates an example process for generating query responses in accordance with some implementations of the disclosed technology. The process 300 can be performed by a system (e.g., generative query system 200) configured to generate a validated response to user queries for information (e.g., network data) associated with a telecommunications network and/or service provider. In one example, the system includes at least one hardware processor and at least one non-transitory memory storing instructions, which, when executed by the at least one hardware processor, cause the system to perform the process 300. In another example, the system includes a non-transitory, computer-readable storage medium comprising instructions recorded thereon, which, when executed by at least one data processor, cause the system to perform the process 300.

At block 302, the system can receive a user query for information associated with a telecommunications network. For example, the system can be configured to display an interactive user interface (e.g., a conversational chatroom) that enables connected end users (e.g., authorized users, staff personnel, and/or the like) to transmit custom natural language queries and/or additional context data (e.g., alphanumeric text, digital file attachments, and/or the like) to the system. In some examples, the system can receive (e.g., via the user interface) a user query that requests retrieval and/or a modified representation (e.g., analytical results and/or graphics generated via statistics inference tools) of network data associated with a telecommunications network and/or service provider. As described herein, the system can further process the initial user input query to generate a natural language response (e.g., or via image, audio, functional code, structured data, and/or alternative information modalities) that satisfies the embedded functional request for retrieving and/or transforming the appropriate stored network information.

At block 304, the system can retrieve a recorded context dialogue (e.g., a turn-based conversation history) of previously generated responses to prior user queries associated with the received user query. For example, the system can access (e.g., from a remote database) a stored data structure comprising an alternating sequence between prior user queries (e.g., input alphanumeric requests and/or questions) and corresponding natural language responses (e.g., provided via generative models) to the prior user queries. Accordingly, the system can apply the stored conversational dialogue (e.g., an alphanumeric text, a structured data sequence, and/or the like) to provide additional context information to generative models (e.g., a machine learning model, a natural language processing algorithm, a large language model, and/or the like) when creating a response to the current user query. In some implementations, the system can assign weighted labels to the recorded context dialogue, or components thereof, which indicates a local content relevancy to the received user query. For example, for each recorded dialogue turn of a prior user query and a previously generated response, the system can assign a relevance score correlating to time elapsed between receiving and/or processing the prior user query and the current user query (e.g., higher priority for contextual dialogue that is proximate to current user query). As a result, the system can dynamically configure generative models (e.g., adjust input prompt instructions, modify model parameters, and/or the like) to generate natural language responses to the received user query based on portions of the context dialogue that focuses on more recent information.

At block 306, the system can determine a sequential model set comprising generative models (e.g., a natural language processing algorithm, a large language model, a small language model, and/or the like) for determining natural language responses to input user queries. For example, the system can obtain an ordered sequence of generative models that are each configured to generate a natural language response to the received user query based on one or more accessible data sources (e.g., structured and/or unstructured network data of a telecommunications network). In some implementations, the system can configure the ordering of the generative models (e.g., of the sequential model set) to be based on one or more data sources (e.g., or data types) of network data accessible to individual generative models for creating the natural language response. As an illustrative example, the system can order the generative models in the sequential model set according to decreasing authorization levels (e.g., allowed visibility of network data) of the one or more data sources accessible to each generative model. In another example, the system can order the generative models according to increasing denormalization (e.g., structured to unstructured data) of data schemas (e.g., formatting restrictions for network data) of the one or more data sources accessible to each generative model.

In some implementations, the system can configure the ordering of the sequential model set using historical dialogue (e.g., recorded queries and responses) unique to a specified user, or user set. For example, the system can access (e.g., from a remote database) a historical dialogue set of one or more historical dialogues (e.g., turn-based conversational data structures), each comprising at least one recorded user query (e.g., an alphanumeric question) and corresponding recorded natural language responses generated via one or more generative models of the sequential model set. Accordingly, the system can use the received user query and the retrieved historical dialogue set as input data for a machine learning model to generate the ordering of the generative models. In some implementations, the individual natural language responses of the historical dialogue set can include an indicator (e.g., a reference label) that identifies whether the responses previously satisfied the corresponding user queries.

At block 308, the system can generate one or more candidate natural language responses (e.g., an unvalidated response) to the received user query via iterating over the sequential model set of generative models. For example, the system can cause a first generative model in the sequential model set to generate a first candidate response to the received user query using the recorded context dialogue and network data sources (e.g., structured network data) accessible to the first generative model. In another example, the system can cause a second generative model in the sequential model set (e.g., following the first generative model) to generate a second candidate response to the received user query using the recorded context dialogue and network data sources (e.g., unstructured network data) accessible to the second generative model. In some implementations, the system can be configured to generate the second candidate response after completion of additional processes described herein with respect to the first candidate response (e.g., user acceptance/rejection of the first candidate response). In other implementations, the system can be configured to cause generation of the second candidate response (e.g., via the second generative model) prior to completing generation of the first candidate response (e.g., via the first generative model). As a result, the system can generate candidate responses via generative models of the sequential model set simultaneously and/or in parallel processes.

In some implementations, the system can augment the generation (e.g., via generative models) of natural language responses using recorded template responses. For example, the system can retrieve (e.g., from a remote database) a set of response template data structures (e.g., a stored JSON, YAML, XML, CSV, and/or the like), each response template comprising a sample user query (e.g., an alphanumeric request) and a corresponding sample response (e.g., a natural language text) previously accepted as satisfying the sample user query. From the response template set, the system can identify at least one sample user query that comprises content similarities to the received user query. For example, the system can compare the received user query to sample user queries of the response template set to identify a subset of sample user queries that share similar content details (e.g., requested network information, output response format, and/or the like) to the received user query. Accordingly, the system can cause each generative model of the sequential model set to generate the candidate natural language response to the received user query using the recorded context dialogue, the network data (e.g., of the telecommunications network), and the identified subset of sample user queries and corresponding sample responses as context information (e.g., additional augmentations to model input prompt).

At block 310, the system can access (e.g., via a remote database) a validation schema that defines a set of natural language features indicating invalid candidate natural language responses generated via the generative models. For example, the system can obtain a set of response features comprising an alphanumeric keyword (e.g., text phrases mapped to common invalid responses), a predetermined response structure (e.g., an enumerated list, a tabular representation, a structured graphic, and/or the like), a response length threshold, and/or any combination thereof. Accordingly, at block 312, the system can display (e.g., at the user interface) the generated candidate natural language response in response to determining that the candidate response satisfies the validation schema (e.g., the natural language feature set).

In some implementations, the system can be configured to generate and/or display additional candidate responses via the generative models of the sequential model set. For example, the system can receive (e.g., via the user interface) a negative user response indicating rejection of the displayed candidate response to the received user query. Accordingly, the system can generate and/or display a second candidate response via a second generative model (e.g., following the first generative model) of the sequential model set using the recorded context dialogue and network data accessible to the second generative model. In another example, the system can be configured to automatically display (e.g., at the user interface) a pre-generated second candidate response (e.g., a response generated in parallel to the previous response) in response to receiving the negative user indication.

In some implementations, the system can generate a second candidate response using additional user queries following the initial received user query. For example, the system can receive a negative user response that comprises a second user query (e.g., a follow-up request, a clarification detail or instruction, additional context information, and/or the like) associated with the received first user query. The system can add the first user query (e.g., the initial received query) and the corresponding first candidate response (e.g., the rejected response) to the recorded context dialogue. Accordingly, the system can cause the second generative model of the sequential model set to generate a second candidate response to the second user query using the updated context dialogue and network data accessible to the second generative model.

### Example Computing Environment

FIG. 4 is a computing environment that can implement aspects of the present technology. In some implementations, environment 400 includes one or more client computing devices 405A-D, examples of which can host the generative query system 200 of FIG. 2A. Client computing devices 405 operate in a networked environment using logical connections through network 430 to one or more remote computers, such as a server computing device.

In some implementations, server 410 is an edge server which receives client requests and coordinates fulfillment of those requests through other servers, such as servers 420A-C. In some implementations, server computing devices 410 and 420 comprise computing systems, such as the generative query system 200 of FIG. 2A. Though each server computing device 410 and 420 is displayed logically as a single server, server computing devices can each be a distributed computing environment encompassing multiple computing devices located at the same or at geographically disparate physical locations. In some implementations, each server 420 corresponds to a group of servers.

Client computing devices 405 and server computing devices 410 and 420 can each act as a server or client to other server or client devices. In some implementations, servers (410, 420A-C) connect to a corresponding database (415, 425A-C). As discussed above, each server 420 can correspond to a group of servers, and each of these servers can share a database or can have its own database. Databases 415 and 425 warehouse (e.g., store) information such as claims data, email data, call transcripts, call logs, policy data and so on. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN) but can also be other wired or wireless networks. In some implementations, network 430 is the Internet or some other public or private network. Client computing devices 405 are connected to network 430 through a network interface, such as by wired or wireless communication. While the connections between server 410 and servers 420 are shown as separate connections, these connections can be any kind of local, wide area, wired, or wireless network, including network 430 or a separate public or private network.

### Example Machine Learning Architecture

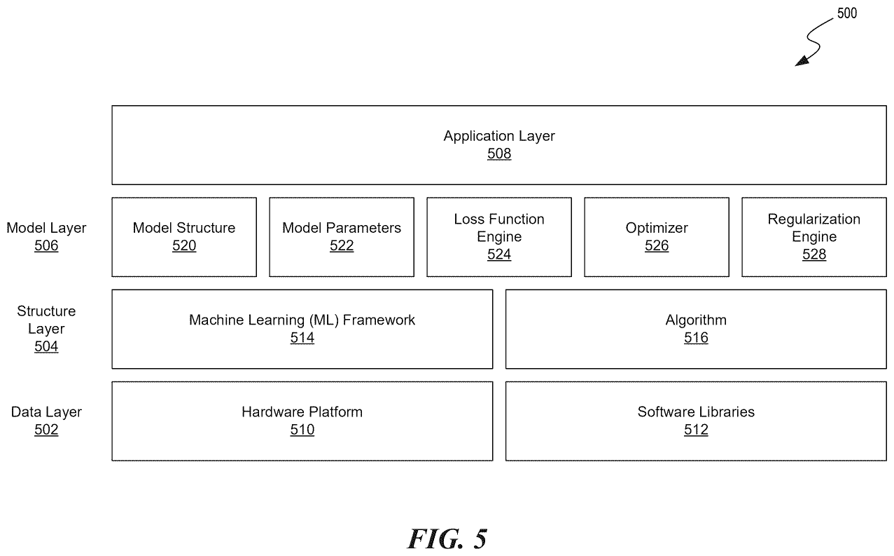

FIG. 5 illustrates a layered architecture of an artificial intelligence (AI) system 500 that can implement the ML models of the generative query system 200 of FIG. 2A, in accordance with some implementations of the present technology. Example ML models can include the models executed by the models stored in the machine learning models database. Accordingly, the machine learning models database can include one or more components of the AI system 500.

As shown, the AI system 500 can include a set of layers, which conceptually organize elements within an example network topology for the AI system's architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

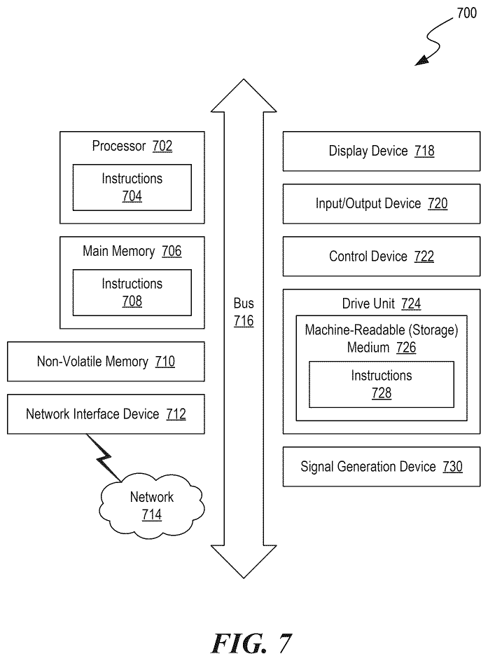

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking, such as the resources described in relation to FIGS. 4 and 7. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, allowing them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that allows users to build and deploy the AI model. The ML framework 514 can include an open-source library, an application programming interface (API), a gradient-boosting library, an ensemble method, and/or a deep learning toolkit that work with the layers of the AI system facilitate development of the AI model. For example, the ML framework 514 can distribute processes for application or training of the AI model across multiple resources in the hardware platform 510. The ML framework 514 can also include a set of pre-built components that have the functionality to implement and train the AI model and allow users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include TENSORFLOW, PYTORCH, SCIKIT-LEARN, KERAS, LightGBM, RANDOM FOREST, and AMAZON WEB SERVICES.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model through being trained while running computing resources of the hardware platform 510. This training allows the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. Furthermore, training data can include historical user queries, recorded natural language responses, and/or accessible network data of the generative query system 200 described in relation to FIG. 2A. The user may label the training data based on one or more classes and trains the AI model by inputting the training data to the algorithm 516. The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model's performance during training. For instance, the loss function engine 524 can measure the difference between a predicted output of the AI model and the actual output of the AI model and is used to guide optimization of the AI model during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over-and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 608 can be communicatively coupled (e.g., display application data, receive user input, and/or the like) to an interactable user interface of the generative query system 200 of FIG. 2A.

### Example Transformer for Machine Learning Models

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

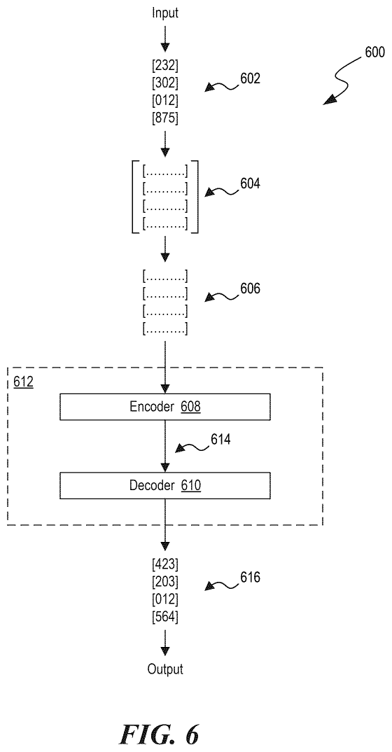

FIG. 6 is a block diagram of an example transformer 612 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 612 includes an encoder 608 (which can comprise one or more encoder layers/blocks connected in series) and a decoder 610 (which can comprise one or more decoder layers/blocks connected in series). Generally, the encoder 608 and the decoder 610 each include a plurality of neural network layers, at least one of which can be a self-attention layer. The parameters of the neural network layers can be referred to as the parameters of the language model.

The transformer 612 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 612 is trained to perform certain functions on other input formats than natural language input. For example, the input can include objects, images, audio content, or video content, or a combination thereof.

The transformer 612 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 6 illustrates an example of how the transformer 612 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], 2, and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 6, a short sequence of tokens 602 corresponding to the input text is illustrated as input to the transformer 612. Tokenization of the text sequence into the tokens 602 can be performed by some pre-processing tokenization module such as, for example, a byte-pair encoding tokenizer (the “pre” referring to the tokenization occurring prior to the processing of the tokenized input by the LLM), which is not shown in FIG. 6 for simplicity. In general, the token sequence that is inputted to the transformer 612 can be of any length up to a maximum length defined based on the dimensions of the transformer 612. Each token 602 in the token sequence is converted into an embedding vector 606 (also referred to simply as an embedding 606). An embedding 606 is a learned numerical representation (such as, for example, a vector) of a token that captures some semantic meaning of the text segment represented by the token 602. The embedding 606 represents the text segment corresponding to the token 602 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 606 corresponding to the “write” token will be closer to another embedding corresponding to the “jot down” token in the vector space as compared to the distance between the embedding 606 corresponding to the “write” token and another embedding corresponding to the “summary” token.

The vector space can be defined by the dimensions and values of the embedding vectors. Various techniques can be used to convert a token 602 to an embedding 606. For example, another trained ML model can be used to convert the token 602 into an embedding 606. In particular, another trained ML model can be used to convert the token 602 into an embedding 606 in a way that encodes additional information into the embedding 606 (e.g., a trained ML model can encode positional information about the position of the token 602 in the text sequence into the embedding 606). In some examples, the numerical value of the token 602 can be used to look up the corresponding embedding in an embedding matrix 604 (which can be learned during training of the transformer 612).

The generated embeddings 606 are input into the encoder 608. The encoder 608 serves to encode the embeddings 606 into feature vectors 614 that represent the latent features of the embeddings 606. The encoder 608 can encode positional information (i.e., information about the sequence of the input) in the feature vectors 614. The feature vectors 614 can have very high dimensionality (e.g., on the order of thousands or tens of thousands), with each element in a feature vector 614 corresponding to a respective feature. The numerical weight of each element in a feature vector 614 represents the importance of the corresponding feature. The space of all possible feature vectors 614 that can be generated by the encoder 608 can be referred to as the latent space or feature space.

Conceptually, the decoder 610 is designed to map the features represented by the feature vectors 614 into meaningful output, which can depend on the task that was assigned to the transformer 612. For example, if the transformer 612 is used for a translation task, the decoder 610 can map the feature vectors 614 into text output in a target language different from the language of the original tokens 602. Generally, in a generative language model, the decoder 610 serves to decode the feature vectors 614 into a sequence of tokens. The decoder 610 can generate output tokens 616 one by one. Each output token 616 can be fed back as input to the decoder 610 in order to generate the next output token 616. By feeding back the generated output and applying self-attention, the decoder 610 is able to generate a sequence of output tokens 616 that has sequential meaning (e.g., the resulting output text sequence is understandable as a sentence and obeys grammatical rules). The decoder 610 can generate output tokens 616 until a special [EOT] token (indicating the end of the text) is generated. The resulting sequence of output tokens 616 can then be converted to a text sequence in post-processing. For example, each output token 616 can be an integer number that corresponds to a vocabulary index. By looking up the text segment using the vocabulary index, the text segment corresponding to each output token 616 can be retrieved, the text segments can be concatenated together, and the final output text sequence can be obtained.

In some examples, the input provided to the transformer 612 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Further Examples

A computer-implemented method performed by a generative query system can include receiving, via a user interface, a user query for information associated with a telecommunications network. The method can include retrieving, from a remote database, a recorded context dialogue of previously generated responses to prior user queries associated with the received user query. The method can include determining a sequential model set of generative models, each configured to generate natural language responses to input user queries using network data of the telecommunications network, wherein ordering of the generative models of the sequential model set is based on network data types accessible to the generative models for generating natural language responses, and wherein at least one generative model of the sequential model set is configured to output natural language responses using structured network data of the telecommunications network. The method can include, for each generative model of the sequential model set, causing the generative model to generate a candidate response to the received user query using the recorded context dialogue and network data corresponding to the accessible network data type of the generative model, accessing a validation schema that defines a natural language feature set for identifying invalid candidate responses generated via the generative model, and responsive to the generated candidate response satisfying the natural language feature set of the validation schema, displaying the candidate response at the user interface.

In some implementations, the received user query is a first user query and the displayed candidate response is a first candidate response. The method can include receiving, via the user interface, a negative user response indicating rejection of the displayed candidate response to the received user query, wherein the negative user response includes a second user query associated with the first user query. The method can include adding the first user query and the first candidate response to the recorded context dialogue of previously generated responses to prior user queries. The method can include causing the generative model of the sequential model set to generate a second candidate response to the second user query using the recorded context dialogue and network data corresponding to the accessible network data type of the generative model.

In some implementations, the method can include retrieving a response template set, each response template including a sample user query and a corresponding sample response previously accepted as satisfying the sample user query. The method can include identifying, via comparison of the received user query to sample user queries of the response template set, at least one sample user query including content similarities to the received user query. The method can include causing the generative model of the sequential model set to generate the candidate response to the received user query using the corresponding sample response of the at least one sample user query, the recorded context dialogue, and the network data corresponding to the accessible network data type of the generative model.

In some implementations, the generative model is a first generative model of the sequential model set and the candidate response is a first candidate response. The method can include accessing, from the sequential model set, a second generative model that sequentially follows the first generative model. The method can include causing the second generative model to generate a second candidate response to the received user query using the recorded context dialogue and network data corresponding to the accessible network data type of the second generative model prior to generating the first candidate response via the first generative model. The method can include responsive to receiving, via the user interface, a negative user response indicating rejection of the first candidate response to the received user query, automatically displaying the second candidate response at the user interface.

In some implementations, the method can include accessing a historical dialogue set, each historical dialogue including at least one recorded user query and a corresponding recorded response generated via generative models of the sequential model set, wherein the recorded response is accepted as satisfying the at least one recorded user query. The method can include determining, via a machine learning model, the ordering of the generative models of the sequential model set based on the received user query and the historical dialogue set.

In some implementations, each accessible network data type for the generative models of the sequential model set corresponds to an authorization level that identifies network data of the telecommunications network visible to the generative models, and wherein the generative models are ordered according to decreasing authorization levels of the accessible network data types for each generative model.

In some implementations, each accessible network data type for the generative models of the sequential model set corresponds to data schemas that define formatting restrictions for network data of the telecommunications network. In some implementations, the generative models are ordered according to increasing denormalization of the data schemas of the accessible network data types for each generative model.

In some implementations, the natural language feature set of the validation schema includes an alphanumeric keyword set, a predetermined response structure, a response length threshold, or a combination thereof.

In some implementations, each prior user query and corresponding previously generated response of the recorded context dialogue is assigned a relevance score correlated to time elapsed between the prior user query and the received user query.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any specific portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method comprising:
receiving, via a user interface, a user query for information associated with a telecommunications network;
retrieving, from a remote database, a recorded context dialogue of previously generated responses to prior user queries associated with the received user query;
determining a sequential model set of generative models, each configured to generate natural language responses to input user queries using network data of the telecommunications network,
wherein ordering of the generative models of the sequential model set is based on network data types accessible to the generative models for generating natural language responses, and
wherein at least one generative model of the sequential model set is configured to output natural language responses using structured network data of the telecommunications network; and
for each generative model of the sequential model set:
causing the generative model to generate a candidate response to the received user query using the recorded context dialogue and network data corresponding to the accessible network data type of the generative model;
accessing a validation schema that defines a natural language feature set for identifying invalid candidate responses generated via the generative model;
responsive to the generated candidate response satisfying the natural language feature set of the validation schema, displaying the candidate response at the user interface.

2. The computer-implemented method of claim 1, wherein the received user query is a first user query and the displayed candidate response is a first candidate response, and wherein the method further comprises:
receiving, via the user interface, a negative user response indicating rejection of the displayed candidate response to the received user query,
wherein the negative user response comprises a second user query associated with the first user query;
adding the first user query and the first candidate response to the recorded context dialogue of previously generated responses to prior user queries; and
causing the generative model of the sequential model set to generate a second candidate response to the second user query using the recorded context dialogue and network data corresponding to the accessible network data type of the generative model.

3. The computer-implemented method of claim 1, further comprising:
retrieving a response template set, each response template comprising a sample user query and a corresponding sample response previously accepted as satisfying the sample user query;
identifying, via comparison of the received user query to sample user queries of the response template set, at least one sample user query comprising content similarities to the received user query; and
causing the generative model of the sequential model set to generate the candidate response to the received user query using the corresponding sample response of the at least one sample user query, the recorded context dialogue, and the network data corresponding to the accessible network data type of the generative model.

4. The computer-implemented method of claim 1, wherein the generative model is a first generative model of the sequential model set and the candidate response is a first candidate response, and wherein the method further comprises:
accessing, from the sequential model set, a second generative model that sequentially follows the first generative model;
causing the second generative model to generate a second candidate response to the received user query using the recorded context dialogue and network data corresponding to the accessible network data type of the second generative model prior to generating the first candidate response via the first generative model; and
responsive to receiving, via the user interface, a negative user response indicating rejection of the first candidate response to the received user query, automatically displaying the second candidate response at the user interface.

5. The computer-implemented method of claim 1, further comprising:
accessing a historical dialogue set, each historical dialogue comprising at least one recorded user query and a corresponding recorded response generated via generative models of the sequential model set,
wherein the recorded response is accepted as satisfying the at least one recorded user query; and
determining, via a machine learning model, the ordering of the generative models of the sequential model set based on the received user query and the historical dialogue set.

6. The computer-implemented method of claim 1,
wherein each accessible network data type for the generative models of the sequential model set corresponds to an authorization level that identifies network data of the telecommunications network visible to the generative models, and
wherein the generative models are ordered according to decreasing authorization levels of the accessible network data types for each generative model.

7. The computer-implemented method of claim 1,
wherein each accessible network data type for the generative models of the sequential model set corresponds to data schemas that define formatting restrictions for network data of the telecommunications network;
wherein the generative models are ordered according to increasing denormalization of the data schemas of the accessible network data types for each generative model.

8. The computer-implemented method of claim 1, wherein the natural language feature set of the validation schema comprises an alphanumeric keyword set, a predetermined response structure, a response length threshold, or a combination thereof.

9. The computer-implemented method of claim 1, wherein each prior user query and corresponding previously generated response of the recorded context dialogue is assigned a relevance score correlated to time elapsed between the prior user query and the received user query.

10. A system comprising:
at least one hardware processor; and
at least one non-transitory memory storing instructions, which, when executed by the at least one hardware processor, cause the system to:
receive, via a user interface, a user query for information associated with a telecommunications network;
retrieve, from a remote database, a recorded context dialogue of previously generated responses to prior user queries associated with the received user query;
determine a sequential model set of generative models, each configured to generate natural language responses to input user queries using network data of the telecommunications network,
wherein ordering of the generative models of the sequential model set is based on network data types accessible to the generative models for generating natural language responses, and
wherein at least one generative model of the sequential model set is configured to output natural language responses using structured network data of the telecommunications network; and
for each generative model of the sequential model set:
cause the generative model to generate a candidate response to the received user query using the recorded context dialogue and network data corresponding to the accessible network data type of the generative model;
access a validation schema that defines a natural language feature set for identifying invalid candidate responses generated via the generative model;
responsive to the generated candidate response satisfying the natural language feature set of the validation schema, display the candidate response at the user interface.

11. The system of claim 10, wherein the received user query is a first user query and the displayed candidate response is a first candidate response, and wherein the system is further caused to:
receive, via the user interface, a negative user response indicating rejection of the displayed candidate response to the received user query,
wherein the negative user response comprises a second user query associated with the first user query;
add the first user query and the first candidate response to the recorded context dialogue of previously generated responses to prior user queries; and
cause the generative model of the sequential model set to generate a second candidate response to the second user query using the recorded context dialogue and network data corresponding to the accessible network data type of the generative model.

12. The system of claim 10 further caused to:
retrieve a response template set, each response template comprising a sample user query and a corresponding sample response previously accepted as satisfying the sample user query;
identify, via comparison of the received user query to sample user queries of the response template set, at least one sample user query comprising content similarities to the received user query; and
cause the generative model of the sequential model set to generate the candidate response to the received user query using the corresponding sample response of the at least one sample user query, the recorded context dialogue, and the network data corresponding to the accessible network data type of the generative model.

13. The system of claim 10, wherein the generative model is a first generative model of the sequential model set and the candidate response is a first candidate response, and wherein the system is further caused to:
access, from the sequential model set, a second generative model that sequentially follows the first generative model;
cause the second generative model to generate a second candidate response to the received user query using the recorded context dialogue and network data corresponding to the accessible network data type of the second generative model prior to generating the first candidate response via the first generative model; and
responsive to receiving, via the user interface, a negative user response indicating rejection of the first candidate response to the received user query, automatically display the second candidate response at the user interface.

14. The system of claim 10 further caused to:
access a historical dialogue set, each historical dialogue comprising at least one recorded user query and a corresponding recorded response generated via generative models of the sequential model set,
wherein the recorded response is accepted as satisfying the at least one recorded user query; and
determine, via a machine learning model, the ordering of the generative models of the sequential model set based on the received user query and the historical dialogue set.

15. The system of claim 10,
wherein each accessible network data type for the generative models of the sequential model set corresponds to data schemas that define formatting restrictions for network data of the telecommunications network;
wherein the generative models are ordered according to increasing denormalization of the data schemas of the accessible network data types for each generative model.

16. A non-transitory, computer-readable storage medium comprising instructions recorded thereon, wherein the instructions when executed by at least one data processor of a system, cause the system to:
receive, via a user interface, a user query for information associated with a telecommunications network;
retrieve, from a remote database, a recorded context dialogue of previously generated responses to prior user queries associated with the received user query;
determine a sequential model set of generative models, each configured to generate natural language responses to input user queries using network data of the telecommunications network,
wherein ordering of the generative models of the sequential model set is based on network data types accessible to the generative models for generating natural language responses, and
wherein at least one generative model of the sequential model set is configured to output natural language responses using structured network data of the telecommunications network; and
for each generative model of the sequential model set:
cause the generative model to generate a candidate response to the received user query using the recorded context dialogue and network data corresponding to the accessible network data type of the generative model;
access a validation schema that defines a natural language feature set for identifying invalid candidate responses generated via the generative model;
responsive to the generated candidate response satisfying the natural language feature set of the validation schema, display the candidate response at the user interface.

17. The non-transitory, computer-readable storage medium of claim 16, wherein the received user query is a first user query and the displayed candidate response is a first candidate response, and wherein the instructions further cause the system to:
receive, via the user interface, a negative user response indicating rejection of the displayed candidate response to the received user query,
wherein the negative user response comprises a second user query associated with the first user query;
add the first user query and the first candidate response to the recorded context dialogue of previously generated responses to prior user queries; and
cause the generative model of the sequential model set to generate a second candidate response to the second user query using the recorded context dialogue and network data corresponding to the accessible network data type of the generative model.

18. The non-transitory, computer-readable storage medium of claim 16, wherein the instructions further cause the system to:
retrieve a response template set, each response template comprising a sample user query and a corresponding sample response previously accepted as satisfying the sample user query;
identify, via comparison of the received user query to sample user queries of the response template set, at least one sample user query comprising content similarities to the received user query; and
cause the generative model of the sequential model set to generate the candidate response to the received user query using the corresponding sample response of the at least one sample user query, the recorded context dialogue, and the network data corresponding to the accessible network data type of the generative model.

19. The non-transitory, computer-readable storage medium of claim 16, wherein the generative model is a first generative model of the sequential model set and the candidate response is a first candidate response, and wherein the instructions further cause the system to:
access, from the sequential model set, a second generative model that sequentially follows the first generative model;
cause the second generative model to generate a second candidate response to the received user query using the recorded context dialogue and network data corresponding to the accessible network data type of the second generative model prior to generating the first candidate response via the first generative model; and
responsive to receiving, via the user interface, a negative user response indicating rejection of the first candidate response to the received user query, automatically display the second candidate response at the user interface.

20. The non-transitory, computer-readable storage medium of claim 16, wherein the instructions further cause the system to:
access a historical dialogue set, each historical dialogue comprising at least one recorded user query and a corresponding recorded response generated via generative models of the sequential model set,
wherein the recorded response is accepted as satisfying the at least one recorded user query; and
determine, via a machine learning model, the ordering of the generative models of the sequential model set based on the received user query and the historical dialogue set.
